(19) United States
(12) Patent Application Publication
(10) Pub. No.: US 2005/0271560 A1
(43) Pub. Date: Dec. 8, 2005

(54) Gas control in a reactor

(75) Inventors: Seth T. Rodgers, Somerville, MA (US); A. Peter Russo, Woburn, MA (US); Timothy J. Johnston, Andover, MA (US); Sean J. LeBlanc, Westminster, MA (US)

Correspondence Address: WOLF GREENFIELD & SACKS, PC;FEDERAL RESERVE PLAZA, 600 ATLANTIC AVENUE, BOSTON, MA, 02210-2211, US

(73) Assignee: BioProcessors Corp., Woburn, MA (US)

(21) Appl. No.: 11/147,415

(22) Filed: Jun. 7, 2005

Related U.S. Application Data
(60) Provisional application No. 60/577,977, filed on Jun. 7, 2004.
(60) Provisional application No. 60/609,721, filed on Sep. 14, 2004.

(51) Int. Cl. B01J 19/00

(52) U.S. Cl. 422/130

(57) ABSTRACT

Chemical, biological, and/or biochemical reaction systems, including chips or reactors, may be configured so as to restrain immiscible materials such as gas bubbles from interfering with the determination of environmental factors associated with the chip according to one aspect of the invention. In another aspect, a chip or other reaction system may be configured to maintain a gas headspace in the chip or other reaction system. In certain embodiments, impediments such as physical barriers may be used to contain gas bubbles within a gas containing region, or otherwise away from a detection region. In other embodiments, surface tension properties may be used to control the location of gas bubbles. The chip or other reaction systems may include reaction site containers that can be very small, for example, having a volume of less than about 2 ml. In certain embodiments, chips or other reaction systems of the invention include one or more reaction sites, which, in some cases, may be defined by reaction site containers. According to another aspect of the invention, a reaction site container may be shaped to limit the formation of gas bubbles during the filling of the reaction site container with liquid by providing reaction site container shapes that do not include sharp angles or abrupt changes in reaction site container width.

### RELATED APPLICATIONS

This application claims priority under 35 U.S.C. § 119(e) to U.S. Provisional Application Ser. No. 60/577,977, filed on Jun. 7, 2004, and U.S. Provisional Application Ser. No. 60/609,721, filed on Sep. 14, 2004.

### FIELD OF THE INVENTION

The present invention generally relates to chemical, biological, and/or biochemical reactor chips and/or reaction systems such as microreactor systems.

### DESCRIPTION OF THE RELATED ART

A wide variety of reaction systems are known for the production of products of chemical and/or biochemical reactions. Chemical plants involving catalysis, biochemical fermenters, pharmaceutical production plants, and a host of other systems are well-known. Biochemical processing may involve the use of a live microorganism (e.g., cells) to produce a substance of interest.

Cells are cultured for a variety of reasons. Increasingly, cells are cultured for proteins or other valuable materials they produce. Many cells require specific conditions, such as a controlled environment. The presence of nutrients, metabolic gases such as oxygen and/or carbon dioxide, humidity, as well as other factors such as temperature, may affect cell growth. Cells require time to grow, during which favorable conditions must be maintained. In some cases, such as with particular bacterial cells, a successful cell culture may be performed in as little as 24 hours. In other cases, such as with particular mammalian cells, a successful culture may require about 30 days or more.

Typically, cell cultures are performed in media suitable for cell growth and containing necessary nutrients. The cells are generally cultured in a location, such as an incubator, where the environmental conditions can be controlled. Incubators traditionally range in size from small incubators (e.g., about 1 cubic foot) for a few cultures up to an entire room or rooms where the desired environmental conditions can be carefully maintained.

As described in International Patent Application Serial No. PCT/US01/07679, published on Sep. 20, 2001 as WO 01/68257, entitled “Microreactors,” incorporated herein by reference, cells have also been cultured on a very small scale (i.e., on the order of a few milliliters or less), so that, among other things, many cultures can be performed in parallel.

### SUMMARY OF THE INVENTION

Each of the following commonly-owned applications directed to related subject matter and/or disclosing methods and/or devices and/or materials useful or potentially useful for the practice of the present invention is incorporated herein by reference: U.S. patent application Ser. No. 10/457,017, filed Jun. 5, 2003, entitled “System and Method for Process Automation,” by Rodgers, et al.; U.S. patent application Ser. No. 10/457,049, filed Jun. 5, 2003, entitled “Materials and Reactor Systems having Humidity and Gas Control,” by Rodgers, et al,. published as 2004/0058437 on Mar. 25, 2004; U.S. patent application Ser. No. 10/457,015, filed Jun. 5, 2003, entitled “Reactor Systems Having a Light-Interacting Component,” by Miller, et al., published as 2004/0058407 on Mar. 25, 2004; U.S. patent application Ser. No. 10/456,929, filed Jun. 5, 2003, entitled “Apparatus and Method for Manipulating Substrates,” by Zarur, et al.; U.S. patent application Ser. No. 10/664,046, filed Sep. 16, 2003, entitled “Determination and/or Control of Reactor Environmental Conditions,” by Miller, et al., published as 2004/0132166 on Jul. 8, 2004; U.S. patent application Ser. No. 10/664,068, filed Sep. 16, 2003, entitled “Systems and Methods for Control of pH and Other Reactor Environmental Conditions,” by Miller, et al., published as 2005/0026134 on Feb. 3, 2005; U.S. patent application Ser. No. 10/664,067 filed on Sep. 16, 2003, entitled “Microreactor Architecture and Methods,” by Rodgers, et al.; and U.S. Patent Application Ser. No. 60/577,985 filed on Jun. 7, 2004, entitled “Control of Reactor Environmental Conditions,” by Rodgers, et al.

The present invention generally relates to chemical, biological, and/or biochemical reactor chips and/or reaction systems such as microreactor systems. The subject matter of this invention involves, in some cases, interrelated products, alternative solutions to a particular problem, and/or a plurality of different uses of one or more systems and/or articles.

According to one embodiment of the invention, an apparatus comprises a chemical, biological, or biochemical reactor chip comprising a reaction site container having a volume of less than about 2 mL, the reaction site container including a detection region and a region, different from the detection region, for holding a first substance. The reactor chip further comprises an impediment positioned in the reaction site container, the impediment constructed and arranged to limit the presence of the first substance, in the presence of a different, immiscible substance, within the detection region.

According to another embodiment of the invention, an apparatus comprises a chemical, biological, or biochemical reactor chip comprising a reaction site container having a volume of less than about 2 mL, the reaction site container including a gas bubble containing region. The reactor chip further comprises an impediment positioned in the reaction site container, the impediment constructed and arranged to contain a gas bubble in the gas bubble containing region.

In another embodiment of the invention, an method comprises adding a liquid sample to a chemical, biological, or biochemical reactor chip, the chip comprising a predetermined gas containing region in fluid communication with a reaction site container having a volume of less than about 2 mL, the chip further comprising a detection region in fluid communication with the reaction site container. The method further comprises placing the chip in a first orientation to move a gas bubble away from the detection region, capturing of the gas bubble in the predetermined gas containing region, detecting a property of the liquid sample present in the detection region, and moving the gas bubble into the detection region by changing the orientation of the chip to a second, different orientation.

In yet another embodiment of the invention, an apparatus comprises a chemical, biological, or biochemical reactor chip comprising a fluid channel in fluid communication with an elongate container having a volume of less than about 2 mL, wherein the container has an interior perimeter surface, a first end, a length, and a maximum width. The interior perimeter surface has a radius of curvature greater than or equal to 93 percent of the maximum container width along the portions of the interior perimeter surface that are: (a) spaced longitudinally from the first container end at a distance of at least 5% of the container length; and (b) spaced longitudinally no further from the first container end than the nearest maximum container width is spaced longitudinally from the first container end.

According to yet another embodiment of the invention, an apparatus comprises a chemical, biological, or biochemical reactor chip comprising a fluid channel in fluid communication with a predetermined reaction site having a volume of less than about 2 milliliters, wherein the predetermined reaction site has an interior perimeter surface that has at least one concave portion and at least one convex portion.

Other advantages and novel features of the invention will become apparent from the following detailed description of the various non-limiting embodiments of the invention when considered in conjunction with the accompanying figures. In cases where the present specification and a document incorporated by reference include conflicting and/or inconsistent disclosure, the present specification shall control. If two (or more) applications incorporated by reference include conflicting and/or inconsistent disclosure with respect to each other, then the later-filed application shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For the purposes of clarity, not every component is labeled in every figure, nor is every component of each embodiment of the invention shown where illustration is not necessary to allow those of ordinary skill in the art to understand the invention. In the figures:

FIG. 1 illustrates one embodiment of the invention including six reactors on a layer of a chip;

FIG. 2a illustrates a top view of a reaction site container having a gas bubble impediment according to one embodiment of the invention;

FIG. 2b illustrates a cross-sectional side view of the embodiment shown in FIG. 2a;

FIGS. 3a-3c illustrate various impediments, specifically physical barriers according to embodiments of the invention;

FIG. 4 shows a top view of another embodiment of the invention including an impediment that is a barrier with a gap;

FIG. 5a illustrates a top view of another embodiment of a gas bubble impediment comprising posts;

FIG. 5b illustrates a side view of the embodiment illustrated in FIG. 5a;

FIGS. 5c-5f illustrate a time sequence progression of gas bubble movement in the embodiment shown in FIGS. 5a and 5b.

FIGS. 6a and 6b illustrate side views of embodiments of the invention which include components that direct gas bubbles into regions of a reaction site;

FIG. 7 illustrates a reaction site container having different surface characteristics in different regions for controlling the location or movement of gas bubbles according to another embodiment of the invention;

FIG. 8 illustrates an embodiment of the invention configured to use surface tension to control the location of a gas bubble;

FIG. 9 illustrates a side view of one embodiment of the invention comprising a physical barrier on a bottom interior surface of a reaction site container;

FIG. 10 illustrates a top view of a reaction site container to illustrate a container shape according to one embodiment of the invention;

FIG. 11a illustrates a top exploded view of a device having multiple layers according to one embodiment of the invention; and

FIG. 11b illustrates a cross-sectional view of an assembled device similar to the embodiment shown in FIG. 11a.

### DETAILED DESCRIPTION

The present invention generally relates to chemical, biological, and/or biochemical reactor chips and/or reaction systems such as microreactor systems, as well as systems and methods for constructing and using such devices. In one aspect of the invention, a chip or other reaction system may be configured so as to restrain gas bubbles from interfering with the determination of environmental factors or other information associated with the chip. In another aspect, a chip or other reaction system may be configured to maintain a gas headspace in the reaction system. According to another aspect of the invention, immiscible materials, such as beads, liquids or gases, are restrained from being present within a detection region of a chip. In certain embodiments, impedimerits such as physical barriers may be used to contain gas bubbles within a gas containing region, or otherwise away from a detection region. In other embodiments, surface tension properties may be used to control the location of gas bubbles or other fluids, in the presence of other, largely immiscible fluids. The chip or other reaction system may include reaction site containers that can be very small, for example, having a volume of less than about 2 milliliters. In some embodiments, the reaction site containers include a surface that is formed with a membrane. In certain embodiments, the chips or other reaction systems of the invention include one or more reaction sites or reaction site containers.

According to one aspect of the invention, a reaction site container may be shaped to limit the formation of gas bubbles during the filing of the container with liquid. For example, the perimeter of the reaction site container may be shaped in some embodiments so that abrupt changes in container width do not occur in a filling region.

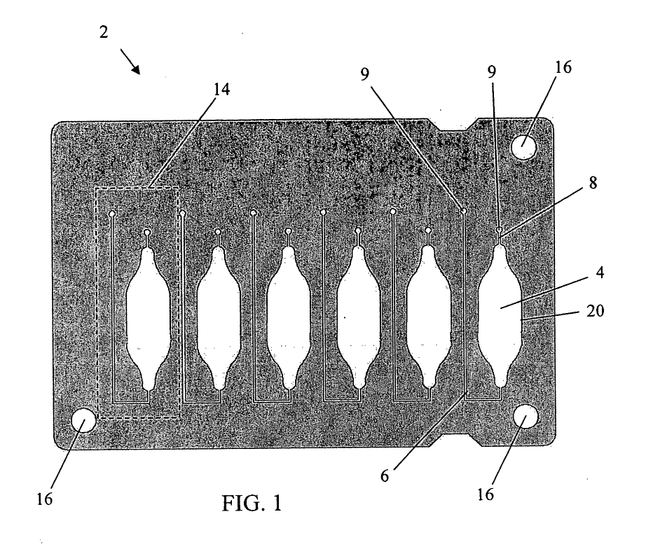

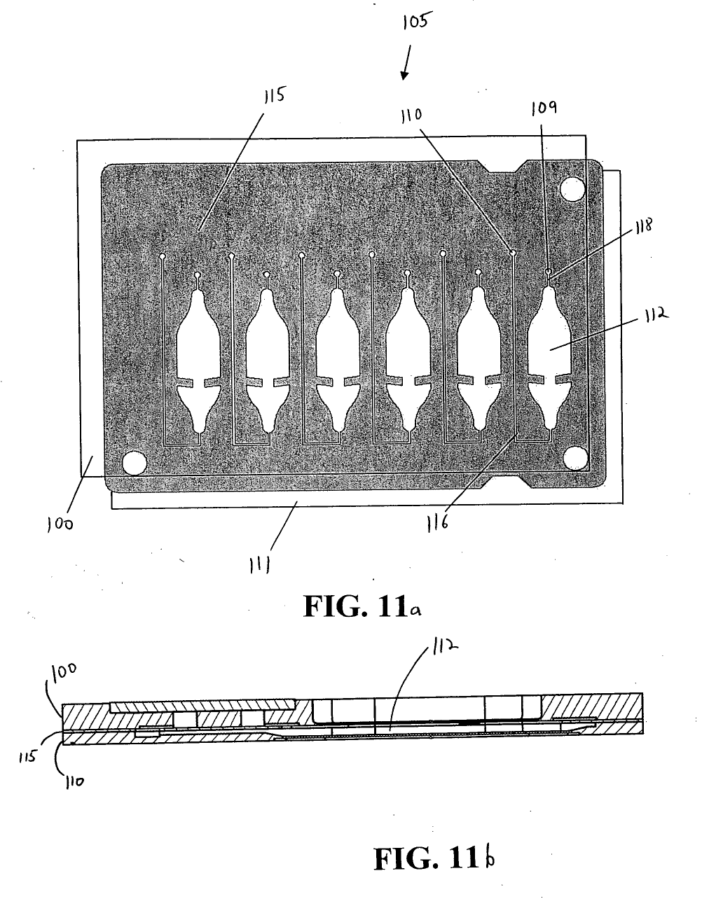

In other embodiments, the presence of residual droplets of liquid left over after liquid removal may be reduced by providing reaction site container shapes that do not include sharp angles or abrupt changes in container width. Referring now to FIG. 1, one portion of a chip according to one embodiment is illustrated schematically. The portion illustrated is a layer 2 which includes within it a series of void spaces which, when layer 2 is positioned between two adjacent layers (not shown), define a series of enclosed channels and reaction sites. The overall arrangement into which layer 2 can be assembled to form a chip will be understood more clearly from the description below with respect to FIGS. 11a and 11b.

FIG. 1 represents an embodiment including six reaction sites 4 (analogous to, for example, reaction site 112 of FIG. 11a, described below) in the form of reaction site containers 20. Reaction sites 4 define a series of generally aligned, elongated voids within a relatively thin, generally planar piece of material defining layer 2. Reaction sites 4 can be addressed by a series of channels including channels 8 for delivering species to reaction sites 4.

Channels 6 and 8 define voids within layer 2 which, when covered above and/or below by other layers, may become enclosed channels. Each of channels 6 and 8, in the embodiment illustrated in FIG. 1, is addressed by a port 9. Where port 9 is fluidly connected to a short channel it may define a liquid port, and where fluidly connected to a long channel it may define a gas port, for example in an arrangement where fluid fills some or all of container 20 through channel 8 while gas is removed from the container via channel 6. In the embodiment illustrated, port 9 is a void that is larger in width than the width of channels 6 or 8. Those of ordinary skill in the art will recognize a variety of techniques for accessing ports 9 and using them to introduce species into channels and/or reaction sites 4. As one example, port 9 can be a “self-sealing” port, addressable by a needle (as described more fully below) when at least one side of port 9 is covered by a layer (not shown) of material which, when a needle is inserted through the material and withdrawn, forms a seal generally impermeable to species such as fluids introduced into the chip via the port.

In FIG. 1, each reaction site 4, along with the associated fluidic connections (e.g., channels 6 and 8, and ports 9), together define a reactor 14, as indicated by dashed lines.

In FIG. 1, layer 2 contains six such reactors, each reactor having substantially the same configuration. In other embodiments, a reactor may include more than one reaction site, and/or additional channels, ports, etc. Additionally, a chip layer may have reactors that do not substantially have the same configuration.

Additionally shown in FIG. 1 is a series of devices 16 which can be used to secure layer 2 to other layers of a chip and/or to assure alignment of layer 2 with other layers and/or other systems to which the chip is desirably coupled. Devices 16 can define screws, posts, indentations (i.e., that match corresponding protrusions of other layers or devices), or the like. Those of ordinary skill in the art are aware of a variety of suitable techniques for securing layers to other layers and/or chips of the invention to other components or systems using devices such as these.

A variety of definitions are now provided which will aid in understanding of the invention. Following, and interspersed with these definitions, is further disclosure, including descriptions of figures, that will fully describe various embodiments of the invention. Components shown in the figures that follow can generally be used in conjunction with layer 2 of FIG. 1. It is to be understood that in FIG. 1, and in all of the other figures, the arrangement of reaction sites, number of reaction sites, arrangement of channels addressing reaction sites, ports, and the like are merely given as examples that fall within the overall invention.

As used herein, a “reactor” is the combination of components including a reaction site, any chambers (including reaction chambers and ancillary chambers), channels, ports, inlets and/or outlets (i.e., leading to or from a reaction site), sensors, actuators, processors, controllers, membranes, and the like, which, together, operate to contain, promote and/or monitor a biological, chemical, and/or biochemical reaction, interaction, operation, or experiment at a reaction site, and which can be part of a chip. For example, a chip may include at least 5, at least 10, at least 20, at least 50, at least 100, at least 500, or at least 1,000 or more reactors. Examples of reactors include chemical or biological reactors and cell culturing devices, as well as the reactors described in International Patent Application No. PCT/US01/07679, filed Mar. 9, 2001, entitled “Microreactor,” by Jury, et al., published as WO 01/68257 on Sep. 20, 2001, incorporated herein by reference. Reactors can include one or more reaction sites or compartments. The reactor may be used for any chemical, biochemical, and/or biological purpose, for example, cell growth, pharmaceutical production, chemical synthesis, hazardous chemical production, drug screening, materials screening, drug development, chemical remediation of warfare reagents, or the like. For example, the reactor may be used to facilitate very small scale culture of cells or tissues. In one set of embodiments, a reactor of the invention comprises a matrix or substrate, or portion thereof, of a few millimeters to centimeters in size, containing channels with dimensions on the order of, e.g., tens or hundreds of micrometers. Reagents of interest may be allowed to flow through these channels, for example to a reaction site, or between different reaction sites, and the reagents may be mixed or reacted in some fashion. The products of such reactions can be recovered, separated, and treated within the reactor or chip in certain cases.

As used herein, a “reaction site” is defined as a site within a reactor that is constructed and arranged to produce a physical, chemical, biochemical, and/or biological reaction during use of the reactor. More than one reaction site may be present within a reactor or a chip in some cases, for example, at least one reaction site, at least two reaction sites, at least three reaction sites, at least four reaction sites, at least 5 reaction sites, at least 7 reaction sites, at least 10 reaction sites, at least 15 reaction sites, at least 20 reaction sites, at least 30 reaction sites, at least 40 reaction sites, at least 50 reaction sites, at least 100 reaction sites, at least 500 reaction sites, or at least 1,000 reaction sites or more may be present within a reactor or a chip. The reaction site may be defined as a region where a reaction is allowed to occur; for example, a reactor may be constructed and arranged to cause a reaction within a channel, one or more compartments or volumetric containers thereof, at the intersection of two or more channels, etc. The reaction may be, for example, a mixing or a separation process, a reaction between two or more chemicals, a light-activated or a light-inhibited reaction, a biological process, and the like. In some embodiments, the reaction may involve an interaction with light that does not lead to a chemical change, for example, a photon of light may be absorbed by a substance associated with the reaction site and converted into heat energy or re-emitted as fluorescence. In certain embodiments, the reaction site may also include one or more cells and/or tissues. Thus, in some cases, the reaction site may be defined as a region surrounding a location where cells are to be placed within the reactor, for example, a cytophilic region within the reactor, or a volumetric cell-culture containing container within the reactor.

A “chemical, biological, or biochemical reactor chip,” (also referred to, equivalently, simply as a “chip”) as used herein, is an integral article that includes one or more reactors. “Integral article” means a single piece of material, or assembly of components integrally connected with each other. As used herein, the term “integrally connected,” when referring to two or more objects, means objects that do not become separated from each other during the course of normal use, e.g., cannot be separated manually; separation requires at least the use of tools, and/or by causing damage to at least one of the components, for example, by breaking, peeling, etc. (separating components fastened together via adhesives, tools, etc.).

A chip can be connected to or inserted into a larger framework defining an overall reaction system, for example, a high-throughput system. The system can be defined primarily by other chips, chassis, cartridges, cassettes, and/or by a larger machine or set of conduits or channels, sources of reactants, cell types, and/or nutrients, inlets, outlets, sensors, actuators, and/or controllers. Typically, the chip can be a generally flat or planar article (i.e., having one dimension that is relatively small compared to the other dimensions); however, in some cases, the chip can be a non-planar article, for example, the chip may have a cubical shape, a curved surface, a solid or block shape, etc.

In some cases, the reactor may include a region containing a gas (e.g., a “gas head space” or a “gas containing region”), for example, if the reaction site is not completely filled with a liquid. The presence of a gas head space permits the addition of liquid to the reactor without forcing liquid out of a different port. When liquid is added to the reactor that has a gas head space in fluid communication with a port, gas, rather than liquid, is forced out of the reactor. In some cases, as described below in further detail, various impediments may be implemented to contain gases within the gas head space, the gas containing region or other regions of the reaction site. In some cases, the gas head space may include various sensors for monitoring temperature, and/or other reaction conditions.

As used here in, “immiscible” defines a relationship between two substances that are largely immiscible with respect to each other, but can be partially miscible. “Immiscible” substances, even if somewhat miscible with each other, will largely remain separate from each other in an observable division. For example, air and water meet this definition, in that a container of the invention containing primarily water or an aqueous solution and some air will largely phase separate into an aqueous portion and a gas bubble or gas region, even though air is slightly soluble in water and water vapor may be present in the air. Other examples of immiscible substances, albeit those that may be somewhat miscible with each other, include oil and water, polymeric bead and water, and the like. Those of ordinary skill in the art will understand, from this definition, and the description that follows involving techniques for managing immiscible substances, the meaning of this term.

According to one aspect of the invention, the reaction site is constructed and arranged to hinder the movement of gas bubbles into a detection region of the reaction site. Chips of the invention can be constructed and arranged so as to be able to detect or determine one or more environmental conditions associated with a reaction site of the reactor, for example, by using a sensor. Many sensors, including optical sensors, make use of optical sensing equipment to measure environmental conditions or the presence of various substances contained in the reaction site. The presence of gas bubbles within the sensing area of the sensor can alter measurement results and lead to inaccuracies. In certain embodiments of the invention, gas bubbles present in the reaction site may be moved to a gas head space or other region that does not affect the determination of various environmental factors within the reaction site.

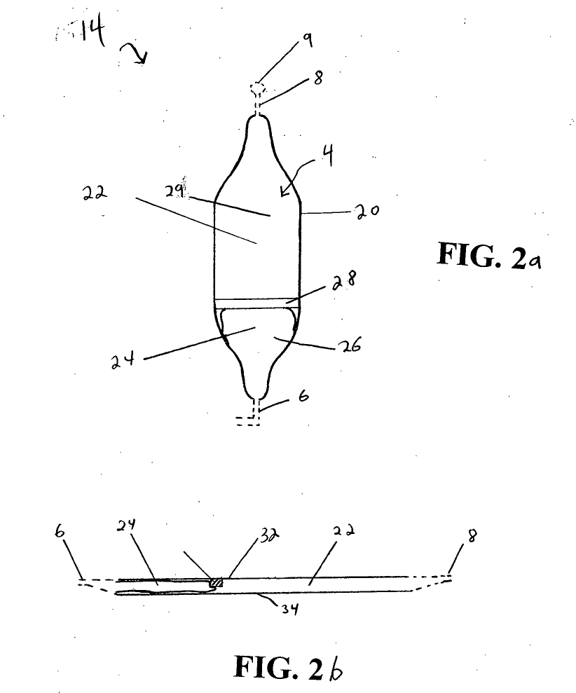

For example, as shown in FIGS. 2a and 2b, a reactor 14 comprises a reaction site container 20 that contains a fluid 22 and a gas bubble 24. Gas bubble 24 is shown in FIGS. 2a and 2b as being contained within a gas containing region 26. An impediment in the form of a physical barrier impedes the movement of gas bubble 24 out of gas containing region 26 and toward reaction site 4, which may contain detection region 29. In this embodiment, the physical barrier is a protrusion 28 which extends approximately halfway from a top interior surface 32 of container 20 to a bottom interior surface 34. When reaction site 4 is held substantially horizontally, protrusion 28 impedes the movement of gas bubble 24.

Gas bubble 24 may be formed during the filling of container 20 with fluid, such as by partially filling container 20 with liquid and leaving a portion, for example 20%-40% in some embodiments or one-third in other embodiments, as the originally present gas (typically air). Additional gas bubbles may form at reaction site 4 after container 20 has been partially filled, such as by evaporation or cellular respiration. When these additional bubbles form, they may initially reside at reaction site 4, such as within detection region 29. To move the gas bubbles away from detection region 29, container 20 may be tilted away from horizontal so that the buoyant forces on the gas bubbles move them into gas containing region 26 where they combine with gas bubble 24. Upon returning container 20 to a substantially horizontal position, movement of gas bubble 24 is impeded by protrusion 28.

The following description of the reaction site container embodiment illustrated in FIGS. 2a and 2b is for one embodiment. It should be understood that numerous other constrictions of further embodiments fall within the scope of the invention. Container 20 is about 11 mm in width at its maximum width, about 1.22 mm in height, and has a total volume of about 375 microliters. The container is fluidly connected to two channels. Channel 8 is 0.5 mm wide by 0.3 mm deep and serves as a liquid inlet. Channel 6 has similar dimension and serves as a gas outlet. The two channels and the cell growth container are etched into a solid support material.

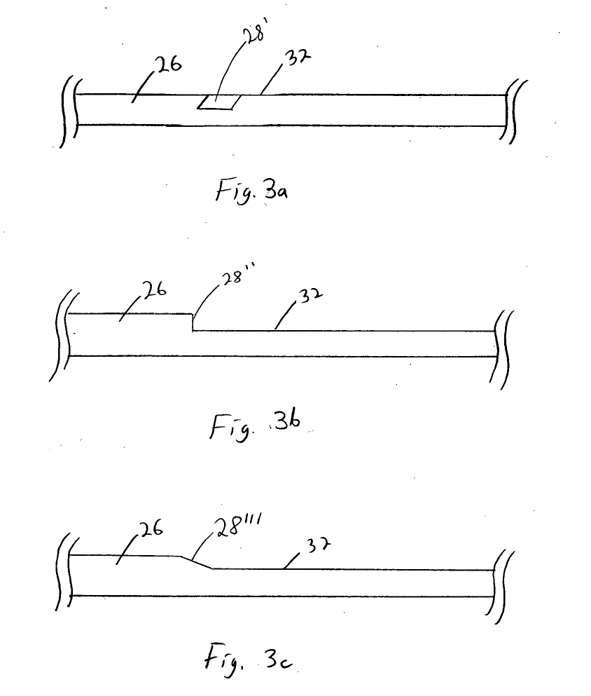

Referring now to FIGS. 3a-3c, several embodiments of protrusions are illustrated. A protrusion that extends downwardly from top interior surface 32 is shown in FIG. 3a. A cross section of the protrusion may be shaped as a rectangle, as shown in FIGS. 2a and 2b, or the protrusion may be any suitable shape, such as a parallelogram protrusion 28′, as illustrated in FIG. 3a. The protrusion may extend any suitable distance from top interior surface 32, and in this embodiment the protrusion leaves adequate clearance for gas bubbles to be moved to the gas-containing region from the detection region by tilting container 20 (i.e., by moving the gas bubble under the protrusion). Once bubbles have been moved to the gas head space region, protrusions 28 can maintain the gas in the head space region under certain chip orientations, such as a flat orientation as illustrated in FIGS. 3a-3c.

Another embodiment of a protrusion is illustrated in FIG. 3b. A step 28″ is present in top interior surface 32 such that the container depth differs in the gas containing region 26 and reaction site 4. Because gas bubbles moving from reaction site 4 toward gas containing region 26 do not encounter a face or a thinner container depth, gas bubbles that form or are present in reaction site 4 may be able to travel to gas containing region 26 more easily than if they encountered protrusions such as the ones shown in FIGS. 2a and 2b.

In yet another embodiment of a protrusion, an inclined plane 28′″ is present in top interior 32 in the embodiment illustrated in FIG. 3c. Similar to the embodiment of FIG. 3b, inclined plane 28′″ may allow gas bubbles to more easily travel from reaction site 4 to gas containing region 26. Additionally, however, inclined plane 28′″ reduces the angles present within the container. As discussed below in more detail, limiting the size of angles within the container may be desirable.

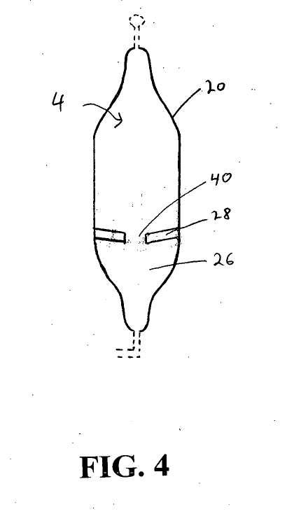

FIG. 4 shows one illustrative embodiment of a reaction site container 20 which has a protrusion 28 with a gap 40. Protrusion 28 is rectangular in cross section and extends a portion of the way from the top interior surface to the bottom interior surface, although protrusion 28 may, in some embodiments, extend all the way from the top interior surface to the bottom interior surface. In this embodiment, gap 40 facilitates the movement of gas bubbles from reaction site 4 to gas containing region 26. Also according to this embodiment, protrusion 28 intersects the perimeter surfaces of container 20 at an angle other than a right angle. Such a configuration may aid in the containment of gas bubbles within gas head space region 26, while allowing gas bubbles to be moved out of reaction site 4 more easily.

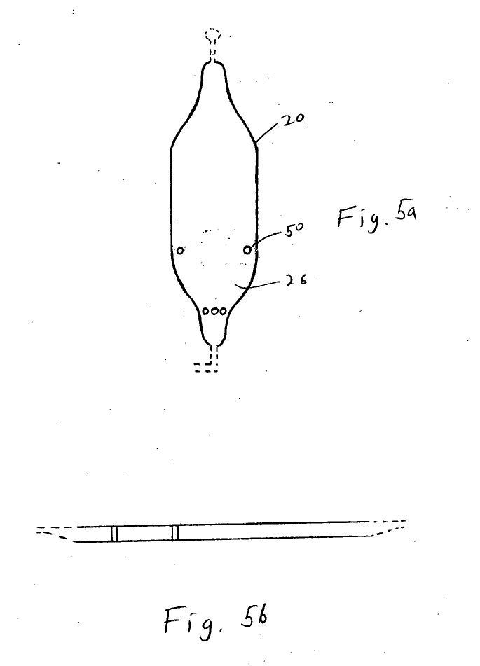

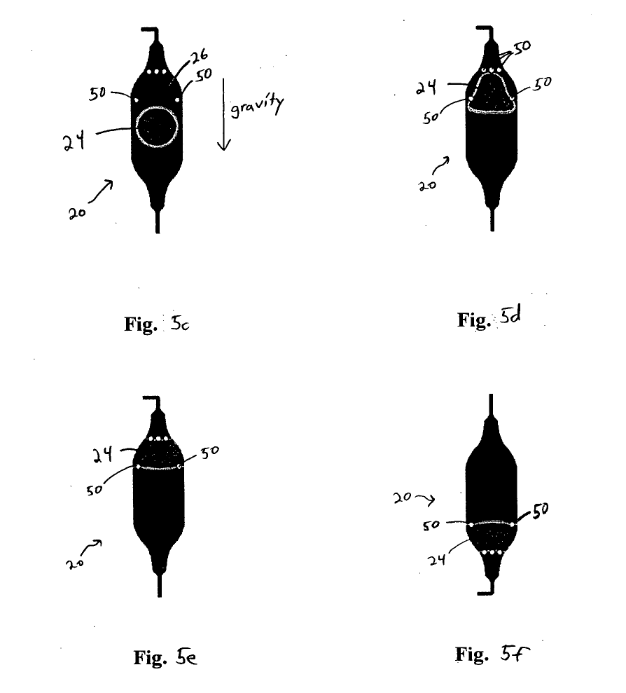

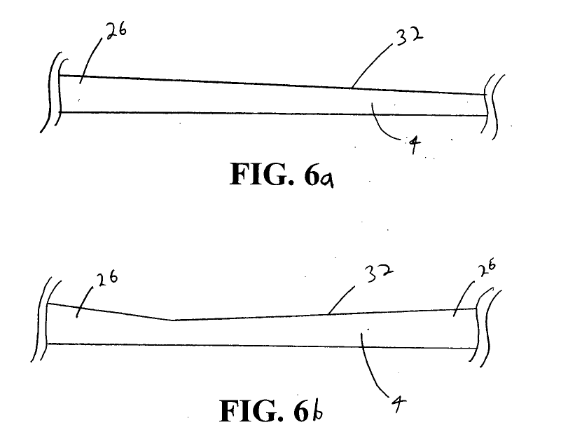

In other embodiments, protrusions such as posts may be used as gas bubble impediments. For example, as shown in FIG. 5a, a plurality of posts 50 may be positioned to restrain a gas bubble. For a given bubble size and set of fluid properties, posts 50 may be positioned such that a gas bubble is permitted to enter gas containing region 26 but is restrained from exiting even when reaction site container 20 is positioned vertically.

A progressive time sequence of gas bubble positions modeled by a computational fluid dynamics simulation is illustrated in FIGS. 5c-5e. In FIG. 5c, gas bubble 24 is contained entirely within reaction site 4. In FIG. 5d, a majority of gas bubble 24 has traveled past (e.g., around) the two front posts. In FIG. 5e, gas bubble 24 is entirely contained by the five posts. In FIG. 5f, the computational fluid dynamics simulation shows that even with reaction site container 20 positioned such that the buoyancy force of gas bubble 24 is directly upward, posts 50 prevent it from leaving gas containing region 26. In certain embodiments, posts 50 having a diameter of 1 mm may be used.

By using posts instead of barriers that extend across a substantial portion of the container, additional area may be available for diffusive mass transport. For example, the top layer of a container may be a membrane, and by using posts, a larger area may be available as a membrane.

A reaction site container may be configured so that gas bubbles are directed toward certain regions even when the container is in a horizontal configuration. In one embodiment, as illustrated in FIG. 6a, a substantial portion of top interior surface 32 may be an inclined plane such that gas bubbles forming at reaction site 4 tend to move toward gas containing region 26 with little or even no tilting of reaction site container 20. In another embodiment, illustrated in FIG. 6b, top interior surface 32 includes a chevron shape so that bubbles forming anywhere in reaction site container 20 move to one of two sides. In other embodiments, a chevron shape or an inclined plane which extends along a limited section of top interior surface 32 may be used. It should be understood that two or more gas containing regions 26 may be present in a reaction site, reactor, and/or chip.

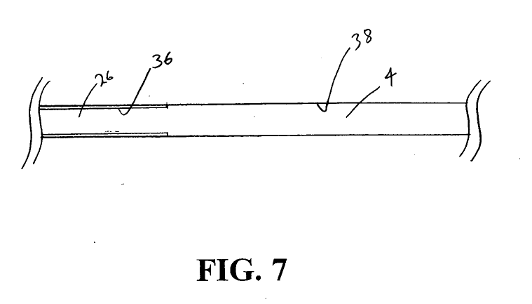

Instead of, or in addition to physical barriers, configurations that take advantage of surface tension properties may be used to control gas bubbles in a chip and/or a reaction system. For example, as shown in FIG. 7, surface coatings having different properties may be used to direct and/or capture gas bubbles, i.e., into a gas containing region. Gas containing region 26 may have an interior surface 36 that is more hydrophobic than an interior surface 38 of reaction site 4. This difference may be achieved by using a material for gas containing region 26 that is more hydrophobic than a material used for interior surface 38 of reaction site 4. In some embodiments, a hydrophobic coating may be used on interior surface 36 of gas containing region 26 that makes it more hydrophobic than interior surface 38 of reaction site 4. This may cause, for instance, the gas-containing region to have a lower energy surface than that of the reaction site. In other embodiments, a hydrophilic coating may be used at reaction site 4 while no coating is used at gas containing region 26. In yet another embodiment, different coatings may be used in both regions.

In some cases, capturing the gas bubble, i.e., in the gas-containing region, comprises having a lower energy interaction between the surface energy of the gas bubble and the surface energy of the gas-containing region than between the surface energy of the gas bubble and the surface energy of a detection region (i.e., of a reaction site). Thus, the gas bubble may favor being held in the gas-containing region compared to the detection region until energy is added to the system to cause the gas bubble to move away from the gas-containing region (i.e., into the detection region).

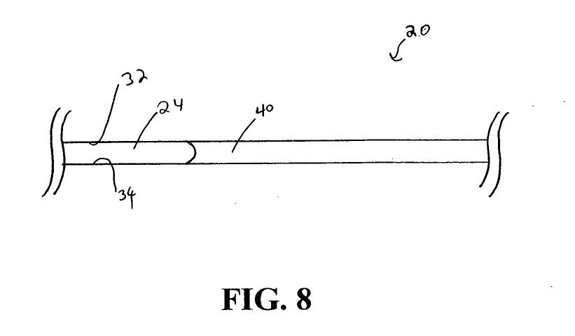

In some embodiments, such as the embodiment illustrated in FIG. 8, the depth of reaction site container 20 may be constructed and arranged such that gas bubbles of a certain size are trapped by the surface tension created by the meniscus of liquid 40. Gas bubble 24 in gas containing region 26 is of sufficient size to reach both top interior surface 32 and bottom interior surface 34. The liquid 40 surrounding gas bubble 24 forms a meniscus and the surface tension of the liquid impedes movement of gas bubble 24. The depth of container 20 may be chosen based on the properties of liquid 40.

Immiscible materials other than gas may be contained in certain regions of a reaction site container. For example, glass beads or liquids which are immiscible in the majority of liquid present in the reaction site may be present in the reaction site. Various impediments such as those described above may be used to help prevent the movement of these immiscible materials into the detection region of the reactor.

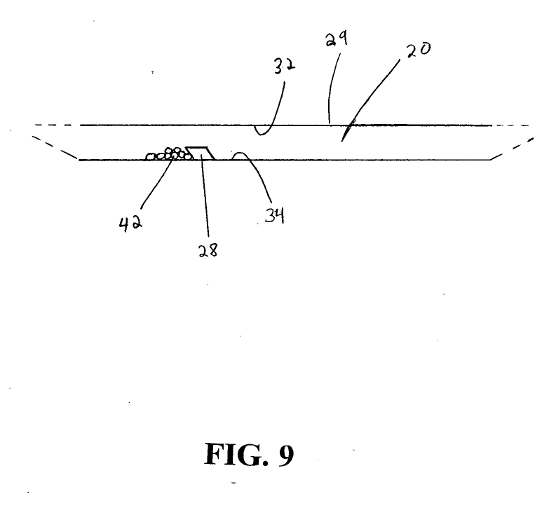

FIG. 9 shows reaction site container 20 with a protrusion 28 on a bottom interior surface 39 of container 20, according to one embodiment of the invention. Beads 42, which in this embodiment have a density greater than the liquid present in container 20, settle to the bottom of container 20 when container 20 is oriented horizontally. Protrusion 28 impedes the movement of beads 42 toward detection region 29. In other embodiments, an immiscible liquid may be present and have either a greater or lesser density than the liquid present in container 20. If the density of the immiscible liquid or other immiscible material is less than that of the majority of liquid, a protrusion may be located on top interior surface 32 of container 20. If the density of the immiscible liquid is greater than that of the majority of liquid, a protrusion may be located on the bottom interior surface 34 of container 20. In some embodiments, protrusions may be present on both the top and bottom interior surfaces of container 20 to be arranged for immiscible materials of either greater or lesser density.

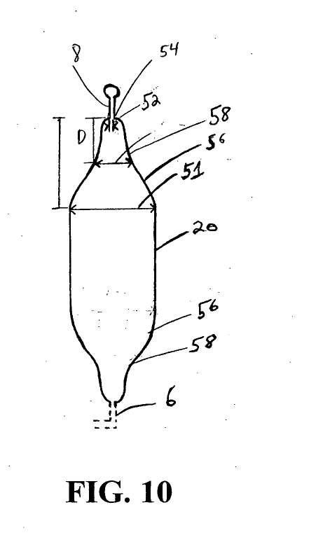

According to another aspect of the invention, the reaction site is shaped to allow liquid to flow into the reaction site container from a container inlet without forming trapped air pockets in the reaction site container. As described above, gas bubbles, such as air bubbles, that are present in the detection region may interfere with measurements, such as optical measurements. It also may be desirable to maintain a gas bubble in the gas headspace region, and trapping air bubbles in the liquid present in the container could reduce the size of the gas bubble in the gas headspace region. To limit the formation of gas bubbles during container filling, in certain embodiments, sidewalls of the reaction site may be formed with smooth walls that do not have sharp angles. Smooth walls may be combined with gradual changes in reaction site width, as shown in the embodiment illustrated in FIG. 10, to further limit the potential for trapping gas bubbles in the liquid. In other embodiments, the sidewalls may have sharp angles, but still employ gradual width changes to allow filling of the reaction site container without trapping excessive gas bubbles.

Removal of fluid at the completion of an experiment can result in droplets being left behind in the reaction site container. It is preferable in many cases to remove as much fluid as possible so that a large sample size may be obtained for analysis. Additionally, in experiments that result in the liquid potentially having heterogeneous concentrations, residual droplets left in the reaction site container can alter analysis results.

Smooth walls and/or gradual reaction site width changes may aid in the removal of liquid from the reaction site by limiting the amount of liquid left behind in the form of droplets on the sidewalls. Sharp angles and/or abrupt width changes may lead to small liquid droplets separating from the main volume of liquid during liquid removal.

One embodiment of a reaction site container having smooth sidewalls and gradual width changes is shown in FIG. 10. Reaction site container 20 has a maximum container width 51 along a center portion of container 20 and a junction width 52 at a junction 54 of container 20 and channel 8. To provide a gradual change in the container width from junction 54 to maximum width 51, the container, at a distance D halfway between junction 54 and the maximum width 51 that is closest to junction 54, has a width less than or approximately equal to the average of maximum container width 51 and junction width 52. In some embodiments, junction width 52 is approximately one-twentieth or less the width of maximum container width 51.

Regarding smooth sidewalls in the reaction site container, the embodiment illustrated in FIG. 10 maintains a minimum radius of curvature so that abrupt width changes are reduced in order to limit areas where air bubbles might form during filling or liquid droplets might remain during emptying. In the embodiment illustrated in FIG. 10, the perimeter maintains a minimum radius of curvature of 0.40″ (1.02 cm) except in the immediate areas of the junctions with channels 6 and 8. In certain embodiments, this minimum radius of curvature may be maintained on the liquid filling side of the reaction site container, but not on the gas headspace side. In some embodiments, at a longitudinal distance from the end of the container of at least 5% of the container length, the interior perimeter surface has a radius of curvature greater than or equal to 93 percent of the maximum container width. In the embodiment shown in FIG. 10, a radius of curvature of 0.06″ (0.15 cm) is present in the immediate area of the junctions 6 and 8.

Reaction site container 20 includes both concave portions 56 and convex portions 58 in the perimeter of the embodiment illustrated in FIG. 10. Such a configuration can help to maintain the flow of liquid within container 20 substantially in the direction of channel flow. By aligning the fluid flow with channel 8, rapid changes in fluid flow direction may be avoided which can reduce the creation of gas bubbles.

FIG. 11a illustrates an assembly of one embodiment of the invention. FIG. 11a illustrates a top view and FIG. 11b illustrates a side view of a chip 105. In this embodiment, chip 105 is composed of three layers of material, namely, upper layer 100 (which is transparent in the embodiment illustrated), interior layer 115, and lower layer 111. Of course, in other embodiments of the invention, chip 105 may have more or fewer layers of material (e.g., including only one layer), depending on the specific application. In the embodiment shown in FIG. 11a, interior layer 115 has one or more void spaces 112, defining a plurality of predetermined reaction sites. One or more channels 116, 118 may also be defined within interior layer 115, and be in fluid communication with reaction site 112. In some cases, one or more ports 109, 110 may allow external access to the channels, for example through upper layer 100. As used herein, “upper,” “lower,” and other descriptors that imply a particular orientation of any device of the invention are illustrative only. For example, an “upper” component of a device is used merely to illustrate a position of that component relative to another component and, while the “upper” component may actually be above other components during use of the device, the device can be oriented in different ways such that the “upper” component is beside, below, or otherwise differently oriented relative to a “lower” component.

Upper layer 100 may cover or at least partially cover interior layer 115, thereby in part defining reaction site(s) 112. In some cases, upper layer 100 may be permeable to a gas or liquid, for example, in cases where a gas or liquid agent is allowed to permeate or penetrate through upper layer 100. For instance, upper layer 100 may be formed from a polymer such as PDMS or silicone, which may be thin enough to allow detectable or measurable gaseous transport therethrough. In some cases, gaseous transport through upper layer 100 may be possible, while the transport of a liquid through upper layer 100 is not generally possible within a reasonable time frame. In certain cases, upper layer 100 may also be substantially transparent or translucent, for example, in embodiments where light is used to initiate a reaction or activate a process (e.g., within the reaction site). In some cases, upper layer 100 may be formed from a polymer that allows the permeation of a gaseous pH-altering agent. In certain instances, upper layer 100 may be formed of a material that is self-sealing, i.e., the material may be penetrated by a solid object but generally regains its shape after such penetration. For example, upper layer 100 may be formed of an elastomeric material which may be penetrated by a mechanical device such as a needle, but which sealingly closes once the needle or other mechanical device is withdrawn.

Interior layer 115 includes six void spaces in the embodiment illustrated in FIG. 11. Of course, in other embodiments, more or fewer void spaces may be present within interior layer 115. In the embodiment illustrated in FIG. 11, a void space in interior layer 115, along with upper layer 100 and lower layer 110, may define reaction site 112. In the embodiment of FIG. 11, there are six reaction sites 112, which are substantially identical; however, in other embodiments of the invention, more or fewer predetermined reaction sites may exist, and the reaction sites may each be the same or different. In the embodiment shown, each void space is substantially identical and has two fluid channels 116, 118 in communication with the void space. Of course, in other embodiments of the invention, there may be more or fewer channels running throughout the chip. In the embodiment of FIG. 11, fluid channel 116 is connected to port 110 in interior layer 115, and fluid channel 118 is connected to port 109 in interior layer 115; in other embodiments, of course, fluid channels 116 and 118 may fluidly connect one or more reaction sites to each other, to one or more fluid ports, and/or to one or more other components within chip 105. In some embodiments of the invention, reaction site 112 and/or one or more fluidic channels may be defined, for example, in one or more layers of the chip, for example, solely within one layer, at a junction between two layers, in a void space that spans three layers, etc.

Ports 109 and 110 may be in fluid communication with one or more reaction site(s) 112. Ports 109 and 110 may be accessible, in some cases, by inserting a needle or other mechanical device through upper layer 100. For example, in some cases, upper layer 100 may be penetrated, or a space in upper layer 100 may permit external access to ports 109 and/or 110. In some cases, upper layer 100 may be composed of a flexible or elastomeric material, which may be self-sealing in some cases. In certain instances, upper layer 100 may have a passage formed therein that allows direct or indirect access to ports 109 and/or 110, or ports 109 and/or 110 may be formed in upper layer 100 and connected to channels 116 and 118 through channels defined within layer 100.

Lower layer 111 forms the bottom of chip 105, as illustrated in FIG. 11. As previously described, parts of lower layer 111 in part may define reaction site 112 in certain instances. In some cases, lower layer 111 may be formed of a relatively hard or rigid material, which may give relatively rigid structural support to chip 105. Of course, in other embodiments, lower layer 111 may be formed of a flexible or elastomeric material (i.e., non-rigid). In some cases, lower layer 111 may contain one or more channels defined therein and/or one or more ports defined therein. In some cases, material defining a boundary of the reaction site, such as lower layer 111 (or upper layer 100), may contain salts and/or other materials, for example, in cases where the materials are reacted in some fashion to produce an agent that is allowed to be transported to or proximate reaction site 112.

In some embodiments, a reaction site containing a liquid sample may be configured for mixing with a mixer, such as a gas bubble, a glass bead, or a liquid that is immiscible with the liquid sample. In these embodiments, the location of the mixer may be controlled, for example to allow the mixer to effectively mix when desired, and such that its presence is limited within the detection region, e.g., it can be kept separate from a detection region of the reaction site during certain operations, such as detection, measurement or sensing operations, so as to not interfere with these operations. Detection of properties of a liquid or other substance within the reaction site or environmental conditions within the reaction site can be performed once it has been determined that the mixer is not located within the detection region of the reaction site. In some embodiments of the invention, an apparatus revolves and/or rotates reaction site (or a reactor, chip, or reaction system containing the reaction site) to move a mixer within a reaction site.

“Elongate,” as used herein when referring to a chamber or substrate or container, or predetermined reaction site of an article, refers to such chamber or substrate or container or predetermined reaction site having a perimetric shape, e.g. of an outer boundary or container, that is characterized by there being a first straight line segment, contained within the outer boundary/container, connecting two points on the outer boundary/container and passing through the geometric center of the chamber or substrate or container or predetermined reaction site that is substantially longer than a second straight line segment, perpendicular to the first line segment, contained within the outer boundary/container, connecting two points on the outer boundary/container—other than the same two points connected by the first line segment—and passing through the geometric center of the chamber or substrate or container or predetermined reaction site. For example, if the article is a planar chip comprising a volumetric container defining a predetermined reaction site characterized by a thickness, measured in a direction perpendicular the plane of the chip and a length and width, measured in mutually perpendicular directions both parallel to the plane of the chip, the predetermined reaction site would be “elongate,” if the length substantially exceeded the width (e.g. as would be the case for a thin, rectangular or ellipsoidal, tear-shaped, etc., predetermined reaction site). An axis co-linear with the longest such straight line segment, contained within the outer boundary/container, connecting two points on the outer boundary/container and passing through the geometric center of the chamber or substrate or container or predetermined reaction site for an elongate chamber, substrate, container or predetermined reaction site is referred to herein as the “longitudinal axis” of the chamber or substrate or predetermined reaction site.

It should be understood that the chips and reactors of the present invention may have a wide variety of different configurations. For example, the chip may be formed from a single material, or the chip may contain more than one type of reactor, reservoir and/or agent. In some cases, the chip may contain more than one system able to alter one or more environmental factor(s) within one or more reaction sites within the chip. For example, the chip may contain a sealed reservoir and an upper layer that a non-pH-neutral gas is able to permeate across.

In some embodiments, two or more components of the chip may be joined using an adhesive material. As used herein, an “adhesive material” is given its ordinary meaning as used in the art, i.e., an auxiliary material able to fasten or join two other materials together. For instance, an adhesive may be used to bind a membrane to a substrate layer defining a reaction site. Non-limiting examples of adhesive materials suitable for use with the invention include silicone adhesives such as pressure-sensitive silicone adhesives, neoprene-based adhesives, and latex-based adhesives. The adhesive may be applied to one or more components of the chip using any suitable method, for example, by applying the adhesive to a component of the chip as a liquid or as a semi-solid material such as a viscoelastic solid. For example, in certain embodiments, the adhesive may be applied to the component(s) using transfer tape (e.g., a tape having adhesive material attached thereto, such that, when the tape is applied to the component, the adhesive, or at least a portion of the adhesive, remains attached to the component when the tape is removed from the component). In one set of embodiments, the adhesive may be a pressure-sensitive adhesive, i.e., the material is not normally or substantially adhesive, but becomes adhesive and/or increases its adhesive strength under the influence of pressure, for example, a pressure greater than about 6 atm or about 13 atm (about 100 psi or about 200 psi). Non-limiting examples of pressure-sensitive adhesives include AR Clad 7876 (available from Adhesives Research, Inc., Glen Rock, Pa.) and Trans-Sil Silicone PSA NT-1001 (available from Dielectric Polymers, Holyoke, Mass.).

In some embodiments, the chip may be constructed and arranged such that one or more reaction sites can be defined, at least in part, by two or more components fastened together as previously described (i.e., with or without an adhesive). In some cases, a reaction site may be free of any adhesive material adjacent to or otherwise in contact with one or more surfaces defining the reaction site, and this can be advantageous, for instance, when an adhesive might otherwise leach into fluid at the reaction site. Of course, an adhesive may be used elsewhere in the chip, for example, in other reaction sites. Similarly, in certain cases, a reaction site may be constructed using adhesive materials, such that at least a portion of the adhesive material used to construct the reaction site remains within the chip such that it is adjacent to or otherwise remains in contact with one or more surfaces defining the reaction site. For instance, in one embodiment, an impediment is formed in an adhesive material positioned in a reaction site container of a chip. The impediment may be in contact with one or more interior surfaces of the container. Of course, other components of the chip may be constructed without the use of adhesive materials, as previously discussed.

The term “detection region,” as used herein, generally refers to a region of the reaction site where sensors may be used to detect or determine environmental conditions. For example, a region of a top layer and/or a bottom layer of a chip may be substantially transparent or semi-transparent such that optical measurements of substance contained within the reaction site may be acquired. In some embodiments, the detection region is contained with a reaction site container so that measurements may be made without moving the substances from the reaction site container or other reaction site.

The term “determining,” as used herein, generally refers to the measurement and/or analysis of a substance (e.g., within a reaction site), for example, quantitatively or qualitatively, or the detection of the presence or absence of the substance. “Determining” may also refer to the measurement and/or analysis of an interaction between two or more substances, for example, quantitatively or qualitatively, or by detecting the presence or absence of the interaction. Examples of techniques suitable for use in the invention include, but are not limited to, gravimetric analysis, calorimetry, pressure or temperature measurement, spectroscopy such as infrared, absorption, fluorescence, UV/visible, FTIR (“Fourier Transform Infrared Spectroscopy”), or Raman; gravimetric techniques; ellipsometry; piezoelectric measurements; immunoassays; electrochemical measurements; optical measurements such as optical density measurements; circular dichroism; light scattering measurements such as quasielectric light scattering; polarimetry; refractometry; or turbidity measurements, including nephelometry.

In some cases, environmental factors at each reaction site may be independently determined. Detection of the environmental condition may occur, for example, by means of a sensor which may be positioned within the reaction site, or positioned proximate the reaction site, i.e., positioned such that the sensor is in communication with a detection region of the reaction site in some manner. In some cases, such detection may occur in real-time. The sensor may be, for example, a pH sensor, an optical sensor, an oxygen sensor, a sensor able to detect the concentration of a substance, or the like. Other examples of sensors are further described below. The sensor may be embedded and integrally connected with the chip (e.g., within a component defining at least a portion of the reaction site a channel in fluidic communication with the reaction site, etc.), or separate from the chip in some cases (e.g., within sensing communication). Also, the sensor may be integrally connected to or separate from the reaction site in certain embodiments.

Many embodiments and arrangements of the disclosed devices are described with reference to a chip, or to a reactor, and those of ordinary skill in the art will recognize that the presently disclosed subject matter can apply to either or both. For example, a channel arrangement may be described in the context of one, but it will be recognized that the arrangement can apply in the context of the other (or, typically, both: a reactor which is part of a chip). It is to be understood that all descriptions herein that are given in the context of a reactor or chip apply to the other, unless inconsistent with the description of the arrangement in the context of the definitions of “chip” and “reactor” herein.

In some embodiments, the reaction site may be defined by geometrical considerations. For example, the reaction site may be defined as a container in a reactor, a channel, an intersection of two or more channels, or other location defined in some fashion (e.g., formed or etched within a substrate that can define a reactor and/or chip). Other methods of defining a reaction site are also possible. In some embodiments, the reaction site may be artificially created, for example, by the intersection or union of two or more fluids (e.g., within one or several channels), or by constraining a fluid on a surface, for example, using bumps or ridges on the surface to constrain fluid flow. In other embodiments, the reaction site may be defined through electrical, magnetic, and/or optical systems. For example, a reaction site may be defined as the intersection between a beam of light and a fluid channel.

The volume of the reaction site can be very small in certain embodiments and may have any convenient size. Specifically, the reaction site may have a volume of less than one liter, less than about 100 ml, less than about 10 ml, less than about 5 ml, less than about 3 ml, less than about 2 ml, less than about 1 ml, less than about 500 microliters, less than about 300 microliters, less than about 200 microliters, less than about 100 microliters, less than about 50 microliters, less than about 30 microliters, less than about 20 microliters or less than about 10 microliters in various embodiments. The reaction site may also have a volume of less than about 5 microliters, or less than about 1 microliter in certain cases. In another set of embodiments, the reaction site may have a dimension that is 2 millimeters deep or less, 500 microns deep or less, 200 microns deep or less, or 100 microns deep or less.

In some cases, cells can be present at the reaction site. Sensor(s) associated with the chip or reactor, in certain cases, may be able to determine the number of cells, the density of cells, the status or health of the cells, the cell type, the physiology of the cells, etc. In certain cases, the reactor can also maintain or control one or more environmental factors associated with the reaction site, for example, in such a way as to support a chemical reaction or a living cell. In one set of embodiments, a sensor may be connected to an actuator and/or a microprocessor able to produce an appropriate change in an environmental factor within the reaction site. The actuator may be connected to an external pump, the actuator may cause the release of a substance from a reservoir, or the actuator may produce sonic or electromagnetic energy to heat the reaction site, or selectively kill a type of cell susceptible to that energy. The reactor can include one or more than one reaction site, and one or more than one sensor, actuator, processor, and/or control system associated with the reaction site(s). It is to be understood that any reaction site or a sensor technique disclosed herein can be provided in combination with any combination of other reaction sites and sensors.

As used herein, a “channel” is a conduit associated with a reactor and/or a chip (within, leading to, or leading from a reaction site) that is able to transport one or more fluids specifically from one location to another, for example, from an inlet of the reactor or chip to a reaction site, e.g., as further described below. Materials (e.g., fluids, cells, particles, etc.) may flow through the channels, continuously, randomly, intermittently, etc. The channel may be a closed channel, or a channel that is open, for example, open to the external environment surrounding the reactor or chip containing the reactor. The channel can include characteristics that facilitate control over fluid transport, e.g., structural characteristics (e.g., an elongated indentation), physical/chemical characteristics (e.g., hydrophobicity vs. hydrophilicity) and/or other characteristics that can exert a force (e.g., a containing force) on a fluid when within the channel. The fluid within the channel may partially or completely fill the channel. In some cases the fluid may be held or confined within the channel or a portion of the channel in some fashion, for example, using surface tension (i.e., such that the fluid is held within the channel within a meniscus, such as a concave or convex meniscus). The channel may have any suitable cross-sectional shape that allows for fluid transport, for example, a square channel, a circular channel, a rounded channel, a rectangular channel (e.g., having any aspect ratio), a triangular channel, an irregular channel, etc. The channel may be of any size within the reactor or chip. For example, the channel may have a largest dimension perpendicular to a direction of fluid flow within the channel of less than about 1000 micrometers in some cases, less than about 500 micrometers in other cases, less than about 400 micrometers in other cases, less than about 300 micrometers in other cases, less than about 200 micrometers in still other cases, less than about 100 micrometers in still other cases, or less than about 50 or 25 micrometers in still other cases. In some embodiments, the dimensions of the channel may be chosen such that fluid is able to freely flow through the channel, for example, if the fluid contains cells. The dimensions of the channel may also be chosen in certain cases, for example, to allow a certain volumetric or linear flowrate of fluid within the channel. In one embodiment, the depth of other largest dimension perpendicular to a direction of fluid flow may be similar to that of a reaction site to which the channel is in fluid communication with. Of course, the number of channels, the shape or geometry of the channels, and the placement of channels within the chip can be determined by those of ordinary skill in the art.

As used herein, a “membrane” is a thin sheet of material, typically having a shape such that one of the dimensions is substantially smaller than the other dimensions, that is permeable to at least one substance in an environment to which it is or can be exposed. In some cases, the membrane may be generally flexible or non-rigid. As an example, a membrane may be a rectangular or circular material with a length and width on the order of millimeters, centimeters, or more, and a thickness of less than a millimeter, and in some cases, less than 100 microns, less than 10 microns, or less than 1 micron or less. The membrane may define a portion of a reaction site and/or a reactor, or the membrane may be used to divide a reaction site into two or more portions, which may have volumes or dimensions which are substantially the same or different. Non-limiting examples of substances to which the membrane may be permeable to include water, O₂, CO₂, or the like. As an example, a membrane may have a permeability to water of less than about 1000 (g micrometer/m² day), 900 (g micrometer/m² day), 800 (g micrometer/m² day), 600 (g micrometer/m² day) or less; the actual permeability of water through the membrane may also be a function of the relative humidity in some cases.

Some membranes may be semipermeable membranes, which those of ordinary skill in the art will recognize to be membranes permeable with respect to at least one species, but not readily permeable with respect to at least one other species. For example, a semipermeable membrane may allow oxygen to permeate across it, but not allow water vapor to do so, or may allow water vapor to permeate across it, but at a rate that is at least an order of magnitude less than that for oxygen. Or a semipermeable membrane may be selected to allow water to permeate across it, but not certain ions. For example, the membrane may be permeable to cations and substantially impermeable to anions, or permeable to anions and substantially impermeable to cations (e.g., cation exchange membranes and anion exchange membranes). As another example, the membrane may be substantially impermeable to molecules having a molecular weight greater than about 1 kilodalton, 10 kilodaltons, or 100 kilodaltons or more. In one embodiment, the membrane may be impermeable to cells, but be chosen to be permeable to varied selected substances; for example, the membrane may be permeable to nutrients, proteins and other molecules produced by the cells, waste products, or the like. In other cases, the membrane may be gas impermeable. Some membranes may be transparent to particular light (e.g. infrared, UV, or visible light; light of a wavelength with which a device utilizing the membrane interacts; visible light if not otherwise indicted). Where a membrane is substantially transparent, it absorbs no more than 50% of light, or in other embodiments no more than 25% or 10% of light, as described more fully herein. In some cases, a membrane may be both semipermeable and substantially transparent. The membrane, in one embodiment, may be used to divide a reaction site constructed and arranged to support cell culture from a second portion, for example, a reservoir. For example, a reaction site may be divided into three portions, four portions, or five portions. For instance, a reaction site may be divided into a first cell culture portion and a second cell culture portion flanking a first reservoir portion and two additional reservoir portions, one of which is separated by a membrane from the first cell culture portion and the other of which is separated by a membrane from the second cell culture portion. One or more membranes may also define one or more walls of a reaction site container. For instance, in one embodiment, a first membrane (e.g., a gas permeable vapor impermeable membrane) defines a first wall of a reaction site container. In another embodiment, a second membrane (e.g., a gas permeable vapor impermeable membranes) defines a second wall of the reaction site container. Of course, those of ordinary skill in the art will be able to design other arrangements, having varying numbers of cell culture portions, reservoir portions, and the like, as described herein.

In some embodiments, the disclosed device may include very small elements, for example, sub-millimeter or microfluidic elements. For example, in some embodiments, the devices may include at least one reaction site having a cross sectional dimension of no greater than, for example, 100 mm, 80 mm, 50 mm, or 10 mm. In some embodiments, the reaction site may have a maximum cross section no greater than, for example, 100 mm, 80 mm, 50 mm, or 10 mm. As used herein, the “cross section” refers to a distance measured between two opposed boundaries of the reaction site, and the “maximum cross section” refers to the largest distance between two opposed boundaries that may be measured. In other embodiments, a cross section or a maximum cross section of a reaction site may be less than 5 mm, less than 2 mm, less than 1 mm, less than 500 micrometers, less than 300 micrometers, less than 100 micrometers, less than 10 micrometers, or less than 1 micrometer or smaller. As used herein, a “microfluidic is chip” is a chip comprising at least one fluidic element having a sub-millimeter cross section, i.e., having a cross section that is less than 1 mm. As one particular non-limiting example, a reaction site may have a generally rectangular shape, with a length of 80 mm, a width of 10 mm, and a depth of 5 mm.

While one reaction site may be able to hold and/or react a small volume of fluid as described herein, the technology associated with the invention also allows for scalability and parallelization. With regard to throughput, an array of many reactors and/or reaction sites within a chip or other device, or within a plurality of chips or other devices, can be built in parallel to generate larger capacities. For example, a plurality of chips (e.g. at least about 10 chips, at least about 30 chips, at least about 50 chips, at least about 75 chips, at least about 100 chips, at least about 200 chips, at least about 300 chips, at least about 500 chips, at least about 750 chips, or at least about 1,000 chips or more) may be operated in parallel, for example, through the use of robotics, for example which can monitor or control the chips automatically.

Additionally, an advantage may be obtained by maintaining production capacity at the small scale of reactions typically performed in the laboratory, with scale-up via parallelization. It is a feature of certain embodiments that many reaction sites may be arranged in parallel within a reactor of a chip and/or within a plurality of chips. Specifically, in certain embodiments, at least five reaction sites can be constructed to operate in parallel, or in other cases at least about 7, about 10, about 30, about 50, about 100, about 200, about 500, about 1,000, about 5,000, about 10,000, about 50,000, or even about 100,000 or more reaction sites can be constructed to operate in parallel, for example, in a high-throughput system. In some cases, the number of reaction sites may be selected so as to produce a certain quantity of a species or product, or so as to be able to process a certain amount of reactant. In certain cases the parallelization of the chips and/or reactors may allow many compounds to be screened simultaneously, or many different growth conditions and/or cell lines to be tested and/or screened simultaneously. Of course, the exact locations and arrangement of the reaction site(s) within the reactor or chip will be a function of the specific application.

Additionally, certain embodiments described herein may be configured to be used in conjunction with a collection chamber connectable ultimately to an outlet of one or more reactors and/or reaction sites of a chip. The collection chamber may have a volume of greater than 10 milliliters or 100 milliliters in some cases. The collection chamber, in other cases, may have a volume of greater than 100 liters or 500 liters, or greater than 1 liter, 2 liters, 5 liters, or 10 liters. Large volumes may be appropriate where the reactors and/or reaction sites are arranged in parallel within one or more chips, e.g., a plurality of reactors and/or reaction sites may be able to deliver a product to a collection chamber.

Chips of the invention can be fabricated using any suitable manufacturing technique for producing a chip having one or more reactors, each having one or multiple reaction sites, and the chip can be constructed out of any material or combination of materials able to support a fluidic network necessary to supply and define at least one reaction site. Non-limiting examples of microfabrication processes include wet etching, chemical vapor deposition, deep reactive ion etching, anodic bonding, injection molding, hot pressing, and LIGA. For example, the chip may be fabricated by etching or molding silicon or other substrates, for example, via standard lithographic techniques. The chip may also be fabricated using microassembly or micromachining methods, for example, stereolithography, laser chemical three-dimensional writing methods, modular assembly methods, replica molding techniques, injection molding techniques, milling techniques, and the like as are known by those of ordinary skill in the art. The chip may also be fabricated by patterning multiple layers on a substrate (which may be the same or different), for example, as further described below, or by using various known rapid prototyping or masking techniques. Examples of materials that can be used to form chips include polymers, silicones, glasses, metals, ceramics, inorganic materials, and/or a combination of these. The materials may be opaque, semi-opaque translucent, or transparent, and may be gas permeable, semi-permeable or gas impermeable. In some cases, the chip may be formed out of a material that can be etched to produce a reactor, reaction site and/or channel. For example, the chip may comprise an inorganic material such as a semiconductor, fused silica, quartz, or a metal. The semiconductor material may be, for example, but not limited to, silicon, silicon nitride, gallium arsenide, indium arsenide, gallium phosphide, indium phosphide, gallium nitride, indium nitride, other Group III/V compounds, Group II/VI compounds, Group III/V compounds, Group IV compounds, and the like, for example, compounds having three or more elements. The semiconductor material may also be formed out of combination of these and/or other semiconductor materials known in the art. In some cases, the semiconductor material may be etched, for example, via known processes such as lithography. In certain embodiments, the semiconductor material may have the from of a wafer, for example, as is commonly produced by the semiconductor industry.

In some embodiments, a chip of the invention may be formed from or include a polymer, such as, but not limited to, polyacrylate, polymethacrylate, polycarbonate, polystyrene, polyethylene, polypropylene, polyvinylchloride, polytetrafluoroethylene, a fluorinated polymer, a silicone such as polydimethylsiloxane, polyvinylidene chloride, bis-benzocyclobutene (“BCB”), a polyimide, a fluorinated derivative of a polyimide, or the like. In one embodiment, a 4-methyl-1-pentene based polyolefin, known under the trade name TPX®, may be used. Combinations, copolymers, or blends involving polymers including those described above are also envisioned. The chip may also be formed from composite materials, for example, a composite of a polymer and a semiconductor material.

In some embodiments, a chip of the invention may be formed from or include a polymer, such as, but not limited to, polyacrylate, polymethacrylate, polycarbonate, polystyrene, polyethylene, polypropylene, polyvinylchloride, polytetrafluoroethylene, a fluorinated polymer, a silicone such as polydimethylsiloxane, polyvinylidene chloride, bis-benzocyclobutene (“BCB”), a polyimide, a fluorinated derivative of a polyimide, or the like.

In one set of embodiments, the chip or other support material includes a polymer. The polymer may include a poly(acetylene) and/or a poly(alkylacetylene). Examples of poly(2-alkylacetylene)s include, but are not limited to, poly(2-hexyne), poly(2-heptyne), poly(2-octyne), poly(2-nonyne), poly(2-decyne), poly(2-undecyne), etc. In one embodiment, the poly(acetylene) comprises a structure: 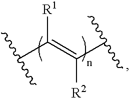
where n is at least 1. R¹ and R² may comprise any atom and/or functional group, for example, hydrogen, a halogen or a pseudohalogen, an alkyl, an aryl, an alkylaryl, an arylalkyl, a cyclic group, a hydroxide, an alcohol, a thiol, a carboxylic acid, a silyl, etc. For example, R¹ and/or R² may each independently be hydrogen or a straight-chain alkyl, such as propyl, pentyl, hexyl, heptyl, octyl, nonyl, decyl, undecyl, etc. In one particular embodiment, the poly(acetylene) is poly(1-trimethylsilyl-1-propyne. In certain cases, R¹ and R² are both H. In another set of embodiments, the polymer may include a structure: 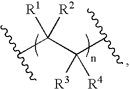
where n is at least 1. Each of R¹, R², R³, and R⁴ may be any atom and/or functional group, e.g., as described above. In one particular embodiment, R¹ is H, R² is H, R³ is H, and R⁴ is H or has a structure: 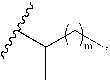
where m is an integer between 0 and 3, inclusive.

Monomers useful for forming some of the above-described polymers are commercially available, for example, from GFS Chemicals, Inc. (Powell, Ohio), or Lancaster Synthesis, Inc. (Windham, N.H.). Suitable techniques for polymerizing the monomers are known to those of ordinary skill in the art, or involve no more than routine modifications of known techniques, and are described, for example, in Pinnau I., et al. “Influence of Side-Chain Length on the Gas Permeation Properties of Poly(2-alkylacetylenes), Macromolecules, 37(8): 2823-2828, 2004. For example, MoCl₅ and/or Ph₄Sn may used to catalyze a polymerization reaction.

The term “halogen,” or equivalently, “halogen atom,” as used herein, is given its ordinary meaning as used in the field of chemistry. The halogens include fluorine, chlorine, bromine, iodine, and astatine, and may have any charge state and/or electronic configuration. In some aspects of the invention, the halogen atoms include one or more of fluorine, chlorine, bromine, or iodine. In certain cases, the halogen atoms are fluorine, chlorine, and bromine; fluorine and chlorine; chlorine and bromine, or a single type of halogen atom.

As used herein, “alkyl” is given its ordinary meaning as used in the field of organic chemistry. Alkyl (i.e., aliphatic) moieties useful for practicing the invention can contain any of a wide number of carbon atoms, for example, between and 1 and 25 carbon atoms, between 1 and 20 carbon atoms, between 1 and 15 carbon atoms, between 1 and 10 carbon atoms, or between 1 and 5 carbon atoms. In some cases, the alkyl moiety will contain at least 1 carbon atom, at least 3 carbon atoms, at least 5 carbon atoms, or at least 10 carbon atoms; in other cases, the alkyl moiety will have at most 10 carbon atoms, at most 5 carbon atoms, or at most 3 carbon atoms.

The carbon atoms within the alkyl moiety may be arranged in any configuration within the alkyl moiety, for example, as a straight chain (i.e., a n-alkyl such as methyl, ethyl, propyl, butyl, pentyl, hexyl, heptyl, octyl, nonyl, decyl, undecyl, etc.) or a branched chain, i.e., a chain where there is at least one carbon atom that is covalently bonded to at least three carbon atoms (e.g., a t-butyl moiety, an isoalkyl moiety such as an isopropyl moiety or an isobutyl moiety, etc.). The alkyl moiety may contain only single bonds, or may contain one or more double and/or triple bonds within its structure, for example, as in an alkene, an alkyne, an alkadiene, an alkadiyne, an alkenyne, etc. In some cases, the alkyl moiety contains only carbon and hydrogen atoms; however, in other cases, the alkyl moiety may also contain one or more substituents, i.e., a non-carbon and non-hydrogen moiety may be present within the alkyl moiety. For example, in certain cases, the alkylinoiety can include a halogen, an alkoxy moiety (e.g., methoxy or ethoxy), an amine moiety (e.g., a primary, secondary, or tertiary amine), a carbonyl (e.g., an aldehyde and/or a ketone) or a hydroxide as a substituent. If more than substituent is present within the alkyl moiety, then the substituents may each be the same or different.

Similarly, a “cyclic” moiety, as used herein, is given its ordinary definition as used in the field of organic chemistry, i.e., a moiety that contains at least one ring of atoms, and may contain more than one ring of atoms. That is, a cyclic moiety has at least one chain of atoms that does not have a terminal end. The chain may have, for example, three, four, five, six, seven, eight, nine, or ten or more atoms arranged in a ring. In some cases, the cyclic moiety has a maximum size of at most ten atoms, at most eight atoms, or at most seven atoms. In some cases, the cyclic moiety may only include carbon and hydrogen atoms; however, in other cases, the atoms within the ring may also include, besides carbon atoms, nitrogen atoms, oxygen atoms, sulfur atoms, silicon atoms, or any other atom able to covalently bond to at least two different atoms (i.e., a “heterocyclic” moiety). If the cyclic moiety contains more than one ring, the rings may be arranged in any orientation with respect to each other, e.g., the rings may be fused (i.e., at least two rings have more than one atom in common, for example, as in bicyclic moieties, tricyclic moieties, etc.), spiro (i.e., two rings have only one atom in common), a ring may be a substituent on another ring, two or more rings may be connected through an alkyl moiety, etc.

The cyclic moiety may be a saturated cyclic moiety (i.e., a moiety not containing any double or triple bonds, such as a cyclopentyl moiety, a cyclohexyl moiety, a cycloheptyl moiety, a cyclooctyl moiety, etc.) or an unsaturated cyclic moiety (i.e., a moiety containing at least one double or triple bond, such as a cycloalkenyl moiety, a cycloalkynyl moiety, an aromatic moiety, etc.). An “aromatic” moiety is given its ordinary meaning as used in the art, i.e., a moiety having at least one ring in which some electrons are delocalized in the ring. For instance, the aromatic moiety may include a benzene moiety, a naphthalenyl moiety, an anthracenyl moiety, a pyridinyl moiety, a furanyl moiety, etc. Similarly, a “non-aromatic” structure is a structure in which aromaticity of the cyclic moiety is not present. For example, a non-aromatic cyclic structure may be a saturated cyclic structure, a cycloalkenyl moiety such as a cyclopentenyl moiety or a cyclohexenyl moiety, a cycloalkynyl moiety such as a cyclooctynyl moiety or a cyclodecynyl moiety, etc.

The cyclic moiety may include one or more substituents in certain cases, for example, attached to a ring within the cyclic moiety. The substituents may be any substituent, for example, as previously described in connection with alkyl moieties, for instance, a halogen, an alkoxy, an amine, a carbonyl, a hydroxide, or the like. In certain cases, a substituent on the cyclic moiety may be an alkyl moiety, as previously described (which itself may include one or more substituents, including other cyclic moieties).

In some cases, the humidity control material may include monomers or polymers in addition to those described above, for example, as in a co-polymer, a polymer blend, a multi-layered structure comprising the above-mentioned polymers in at least one layer, etc. Non-limiting examples of polymers that may be used within the humidity control material, in addition to the polymers described above, include polyfluoroorganic materials such as polytetrafluoroethylenes (e.g., such as those marketed under the name TEFLON® by DuPont of Wilmington, Del., for example, TEFLON® AF) or certain amorphous fluoropolymers; polystyrenes; PP; silicones such as polydimethylsiloxanes; polysulfones; polycarbonates; acrylics such as polymethyl acrylate and polymethyl methacrylate; polyethylenes such as high-density polyethylenes (“HDPE”), low-density polyethylenes (“LDPE”), linear low-density polyethylenes (“LLDPE”), ultra low-density polyethylenes (“ULDPE”) etc.; PET; polyvinylchloride (“PVC”) materials, such as those marketed under the name SARAN® by Dow Chemical Co. of Midland, Mich.; nylons such as that marketed under the name DARTEK® by Dupont; a thermoplastic elastomer; poly(1-trimethlsilyl-1-propyne) (“PTMSP”); and the like. Another example of a suitable material is a BIOFOIL™ polymer membrane, made by VivaScience (Hannover, Germany). Yet another example is poly(4-methyl-1-pentene) (“PMP”): 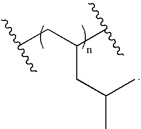
Examples of PMPs include those marketed under the name TPX™ by Mitsui Plastics (White Plains, N.Y.). As still another example, humidity control material may include poly(4-methylhexene-1), poly(4-methylheptene-1) poly(4-methyloctene-1), etc, for example, copolymerized and/or in a polymer blend with the polymers as described above.

In some cases, the polymer (or mixture of polymers) used in the humidity control material may be sufficiently hydrophobic such that the polymer is able to retain water (i.e., water vapor is not able to readily transport through the polymer). For instance, the permeability of water through a hydrophobic polymer may be less than about 1000 (g micrometer/m² day), 900 (g micrometer/m² day), 800 (g micrometer/m² day), 600 (g micrometer/m² day) or less. In certain embodiments, the polymer(s) used in the humidity control material may have a molecular structure open enough to readily allow the transport of oxygen therethrough.

In another set of embodiments, the humidity control material may include a polymer that has bulky groups that prevent the polymer from readily forming a structure under ambient conditions that limits the transport of oxygen therethrough. A “bulky group” on a polymer, as used herein, is a moiety sufficiently large that the polymer is unable to form a crystalline structure under ambient conditions that limits the transport of oxygen therethrough to less than about 1000 (cm³_{STP} micrometer/m² day) or 500 (cm³_{STP} micrometer/m² day). The bulky group may be, for instance, part of the backbone of the polymer or a side chain. Non-limiting examples of bulky side groups include groups containing cyclopentyl moieties, isopropyl moieties, cyclohexyl moieties, phenyl moieties, isobutyl moieties, tert-butyl moieties, cycloheptyl moieties, trimethylsilyl or other trialkylsilyl moieties etc. For example, in one set of embodiments, the polymer may have a structure: 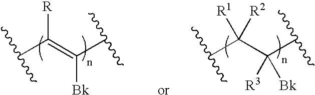
where each R independently comprises at least one atom, and Bk is a bulky group. In some cases, R may be a hydrogen or an alkyl group.

Combinations, copolymers, or blends involving polymers including those described above are also envisioned. The chip may also be formed from composite materials, for example, a composite of a polymer and a semiconductor material.

In some embodiments, the chip, or at least a portion thereof, is rigid, such that the chip is sufficiently sturdy in order to be handled by commercially-available microplate-handling equipment, and/or such that the chip does not become deformed after routine use. Those of ordinary skill in the art are able to select materials or a combination of materials for chip construction that meet this specification, while meeting other specifications for use for which a particular chip is intended. In other embodiments, however, the chip may be semi-rigid or flexible.

As used herein, an “environmental factor” or an “environmental condition” is a detectable and/or measurable condition (e.g., by a sensor) of the environment within and/or associated with a reaction site, such as the temperature or pressure. The factor or condition may be detected and/or measured within the reaction site, and/or at a location proximate to the reaction site such that the environmental condition within the reaction site is known and/or controlled. For example, the environmental factor may be the concentration of a gas or a dissolved gas within the reaction site or associated with the reaction site. The gas may be, for example, oxygen, nitrogen, water (i.e., the relative humidity), CO₂, or the like. The environmental factor may also be a concentration of a substance in some cases. For example, the environmental factor may be an aggregate quantity, such as molarity, osmolarity, salinity, total ion concentration, pH, color, optical density, or the like. The concentration may also be the concentration of one or more compounds present within the reaction site, for example, an ion concentration such as sodium, potassium, calcium, iron or chloride ions; or a concentration of a biologically active compound, such as a protein, a lipid, or a carbohydrate source (e.g., a sugar) such as glucose, glutamine, pyruvate, apatite, an amino acid or an oligopeptide, a vitamin, a hormone, an enzyme, a protein, a growth factor, a serum, or the like. In some embodiments, the substance within the reaction site may include one or more metabolic indicators, for example, as would be found in media, or as produced as a waste products from cells. If cells are present, the sensor may also be a sensor for determining all viability, cell density, cell motility, cell differentiation, cell production (e.g., of proteins, lipids, small molecules, drugs, etc.), etc.

The environmental factor may also be a fluid property of a fluid within the reaction site, such as the pressure, the viscosity, the turbidity, the shear rate, the degree of agitation, or the flowrate of the fluid. The fluid may be, for instance, a liquid or a gas. In one set of embodiments, the environmental factor is an electrical state, for example, the charge, current, voltage, electric field strength, or resistivity or conductivity of the fluid or another substance within the reaction site. In one set of embodiments, the environmental condition is temperature or pressure. In certain embodiments, the sensor may be a ratiometric sensor, i.e., a sensor able to determine a difference or ratio between two (or more) signals, e.g., a measurement and a control signal, two measurements, etc.

Non-limiting examples of sensors useful in the invention include dye-based detection systems, affinity-based detection systems, microfabricated gravimetric analyzers, CCD cameras, optical detectors, optical microscopy systems, electrical systems, thermocouples and thermistors, pressure sensors, etc. Those of ordinary skill in the art will be able to identify other sensors for use in the invention. For example, in one set of embodiments, the chip may contain a sensor comprising one or more detectable chemicals responsive to one or more environmental factors, for example, a dye (or a combination of dyes), a fluorescent molecule, etc. One or more dyes, or fluorescent or chromogenic molecules sensitive to a specific environmental condition(s) may be chosen by those of ordinary skill in the art.

The sensor can include a colorimetric detection system in some cases, which may be external to the chip, or microfabricated into the chip in certain cases. In one embodiment, the colorimetric detection system can be external to the chip, but optically coupled to the reaction site, for example, using fiber optics or other light-interacting components that may be embedded in the chip (e.g., such as those described below). As an example of a calorimetric detection system, if a dye or a fluorescent molecule is used, the colorimetric detection system may be able to detect a change or shift in the frequency and/or intensity of the dye or fluorescent molecule in response to a change or shift in one or more environmental factors within a reaction site. As a specific example, Ocean Optics Inc. (Dunedin F.O.) provides fiber optic probes and spectrometers for the measurement of pH and dissolved oxygen concentration.

In some embodiments of the invention, a reactor and/or a reaction site within a chip may be constructed and arranged to maintain an environment that promotes the growth of one or more types of living cells, for example, simultaneously. In some cases, the reaction site may be provided with fluid flow, oxygen, nutrient distribution, etc., conditions that are similar to those found in living tissue, for example, tissue that the cells originate from. Thus, the chip may be able to provide conditions that are closer to in vivo than those provided by batch culture systems. In embodiments where one or more cells are used in the reaction site, the cells may be any cell or cell type, for instance a prokaryotic cell (e.g., a bacterial cell) or a eukaryotic cell (e.g., a mammalian cell). The precise environmental conditions necessary in the reaction site for a specific cell type or types may be determined by those of ordinary skill in the art.

In some instances, the cells may produce chemical or biological compounds of therapeutic and/or diagnostic interest, for instance, in nanogram, microgram, milligram or gram or higher quantities. For example, the cells may be able to produce products such as monoclonal antibodies, proteins such as recombinant proteins, amino acids, hormones, vitamins, drug or pharmaceuticals, other therapeutic molecules, artificial chemicals, polymers, tracers such as GFP (“green fluorescent protein”) or luciferase, etc. In one set of embodiments, the cells may be used for drug discovery and/or drug developmental purposes. For instance, the cells may be exposed to an agent suspected of interacting with the cells. Non-limiting examples of such agents include a carcinogenic or mutagenic compound, a synthetic compound, a hormone or hormone analog, a vitamin, a tracer, a drug or a pharmaceutical, a virus, a prion, a bacteria, etc. For example, in one embodiment, the invention may be used in automating cell culture to enable high-throughput processing of monoclonal antibodies and/or other compounds of interest. In another embodiment, the invention may be used to screen cells, cell types, cell growth conditions, or the like, for example, to determine self viability, self production rates, etc. In some cases, the invention may be used in high throughput screening techniques. For example, the invention may be used to assess the effect of one or more selected compounds on cell growth, normal or abnormal biological function of a cell or cell type, expression of a protein or other agent produced by the cell, or the like. The invention may also be used to investigate the effects of various environmental factors on cell growth, cell biological function, production of a cell product, etc.

In certain cases, a reactor and/or a reaction site within a chip may be constructed and arranged to prevent, facilitate, and/or determine a chemical or a biochemical reaction with the living cells within the reaction site (for example, to determine the effect, if any, of an agent such as a drug, a hormone, a vitamin, an antibiotic, an enzyme, an antibody, a protein, a carbohydrate, etc. on a living cell). For example, one or more agents suspected of being able to interact with a cell may be added to a reactor and/or a reaction site containing the cell, and the response of the cell to the agent(s) may be determined, using the systems and methods of the invention.

In one aspect, the present invention provides any of the above-mentioned chips packaged in kits, optionally including instructions for use of the chips. That is, the kit can include a description of use of the chip, for example, for use with a microplate, or an apparatus adapted to handle microplates. As used herein, “instructions” can define a component of instruction and/or promotion, and typically involve written instructions on or associated with packaging of the invention. Instructions also can include any oral or electronic instructions provided in any manner such that a user of the chip will clearly recognize that the instructions are to be associated with the chip. Additionally, the kit may include other components depending on the specific application, for example, containers, adapters, syringes, needles, replacement parts, etc. As used herein, “promoted” includes all methods of doing business including methods of education, hospital and other clinical instruction, scientific inquiry, drug discovery or development, academic research, pharmaceutical industry activity including pharmaceutical sales, and any advertising or other promotional activity including written, oral and electronic communication of any form, associated with the invention.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of”, when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one act, the order of the acts of the method is not necessarily limited to the order in which the acts of the method are recited.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An apparatus, comprising:
a chemical, biological, or biochemical reactor chip comprising a reaction site container having a volume of less than about 2 mL, the reaction site container including a detection region and a region, different from the detection region, for holding a first substance;
an impediment positioned in the reaction site container, the impediment constructed and arranged to limit the presence of the first substance, in the presence of a different, immiscible substance, within the detection region.

2. An apparatus as in claim 1, wherein the impediment is constructed and arranged to position the first substance within the reaction site container on a first side of the impediment by placing the chip in a first orientation, and to position the substance on a second side of the impediment within the detection region by placing the chip in a second orientation.

3. An apparatus as in claim 2, wherein the impediment is constructed and arranged to hold the first substance within the reaction site container on the first side of the impediment when the chip is in a substantially horizontal orientation.

4. An apparatus as in claim 1, a first wall of the reaction site container is defined by a first gas permeable, liquid vapor impermeable membrane.

5. An apparatus as in claim 1, wherein the impediment is a physical barrier on an interior surface of the container.

6. An apparatus as in claim 5, wherein the physical barrier extends across an entire width of the container.

7. An apparatus as in claim 5, wherein the physical barrier includes a gap.

8. An apparatus as in claim 5, wherein the physical barrier comprises a step.

9. An apparatus as in claim 5, wherein the physical barrier comprises an inclined plane.

10. An apparatus as in claim 5, wherein the physical barrier comprises a post that extends from a first interior surface of the container to a second interior surface of the reaction site container.

11. An apparatus as in claim 5, wherein the physical barrier comprises a protrusion that extends from the interior surface of the reaction site container, and extends at least partially into the reaction site container.

12. An apparatus as in claim 11, wherein the protrusion is rectangular in cross section.

13. An apparatus as in claim 5, wherein the physical barrier is integral to the interior surface of the reaction site container.

14. An apparatus as in claim 1, wherein the impediment comprises an interior surface of the detection region that has a different affinity for an aqueous-based solution than an interior surface of other portions of the reaction site container.

15. An apparatus as in claim 14, wherein the interior surface of the detection region has a surface coating that is hydrophilic.

16. An apparatus as in claim 14, wherein the interior surface of a portion of the reaction site container other than the detection region has a surface coating that is hydrophobic.

17. An apparatus as in claim 1, wherein the impediment comprises a region of the reaction site container having a preselected depth such that surface tension of liquid present in the chip restrains movement of the gas bubble, the preselected depth being different than a depth of the detection region.

18. An apparatus as in claim 1, wherein the chip at least partially comprises a material comprising a polymer including a structure: 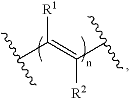
wherein n is at least 1, and each of R¹ and R² independently comprises an atom.

19. An apparatus as in claim 1, wherein the chip at least partially comprises a material comprising a polymer including a structure: 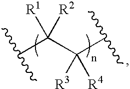
wherein n is at least 1, and each of R¹, R², R³, and R⁴ independently comprises an atom.

20. An apparatus as in claim 1, wherein the detection region comprises a substantially transparent region.

21. An apparatus as in claim 1, wherein the chip is able to maintain at least one living cell.

22. An apparatus as in claim 21, wherein the at least one living cell is mammalian.

23. An apparatus as in claim 4, further comprising a second gas permeable, liquid vapor impermeable membrane allowing oxygen transfer into the container, said second membrane defining a second wall of the container.

24. An apparatus as in claim wherein the chip further comprises an inlet port and an outlet port in fluid communication with the reaction site container.

25. An apparatus as in claim 24, further comprising a self-sealing elastomeric material connected to the chip, the self-sealing elastomeric material defining portions of the inlet and outlet ports.

26. An apparatus as in claim 1, wherein the reaction site container is defined by a void in a substrate layer.

27. An apparatus as in claim 26, wherein an adhesive layer binds a first gas permeable vapor impermeable membrane to the substrate layer.

28. An apparatus as in claim 27, wherein the impediment is formed in the adhesive layer.

29. An apparatus as in claim 1, wherein the impediment comprises at least one post extending from a top or a bottom interior surface of the reaction site container.

30. An apparatus as in claim 1, wherein the impediment comprises at least two posts extending from the top or the bottom interior surface of the reaction site container.

31. An apparatus as in claim 29, wherein the post has a cross-sectional dimension of less than a width of the reaction site container at the position of the post within the reaction site container.

32. An apparatus as in claim 29, wherein the post has a cross-sectional dimension of less than 25% of a width of the reaction site container at the position of the post within the reaction site container.

33. An apparatus as in claim 29, wherein the post has a cross-sectional dimension of less than or equal to about 9% of a width of the reaction site container at the position of the post within the reaction site container.

34. An apparatus as in claim 29, wherein the post extends from the top interior surface to the bottom interior surface of the container.

35. An apparatus as in claim 29, wherein the first post and a second post are positioned within the reaction site container to limit the presence of the first substance within the detection region, the apparatus further comprising a third post and a fourth post each positioned closer to an outlet end of the container than the first and second posts are positioned from the outlet end, the third and fourth posts constructed and arranged to restrain the first substance from exiting the outlet end of the container when the container is positioned vertically.

36. An apparatus, comprising:
a chemical, biological, or biochemical reactor chip comprising a reaction site container having a volume of less than about 2 mL, the reaction site container including a gas bubble containing region; and
an impediment positioned in the reaction site container, the impediment constructed and arranged to contain a gas bubble in the gas bubble containing region.

37. An apparatus as in claim 36, wherein the impediment occupies no more than half of the cross-sectional area of the container immediately adjacent the impediment.

38. An apparatus as in claim 36, wherein the impediment is constructed and arranged to contain a gas bubble in the gas bubble containing region while the chip is in a substantially horizontal orientation.

39. An apparatus as in claim 36, wherein the chip further comprises a channel fluidly connected to the gas bubble containing region.

40. An apparatus as in claim 36, wherein the impediment is a protrusion from a layer of the chip.

41. An apparatus as in claim 40, wherein the protrusion comprises a step.

42. An apparatus as in claim 40, wherein the protrusion comprises an inclined plane.

43. An apparatus as in claim 40, wherein the protrusion comprises a post.

44. An apparatus as in claim 36, wherein the reaction site container further includes a detection region separate from the gas bubble containing region.

45. An apparatus as in claim 44, further comprising a detector for detecting conditions of a sample contained within the detection region of the reaction site container.

46. An apparatus as in claim 45, wherein the detector is at least one of an optical detector, an electrical detector, a capacitance detector, a conductance detector, an electromagnetic detector, and a fluorescent detector.

47. A method, comprising:
adding a liquid sample to a chemical, biological, or biochemical reactor chip, the chip comprising a predetermined gas containing region in fluid communication with a reaction site container having a volume of less than about 2 mL, the chip further comprising a detection region in fluid communication with the reaction site container;
placing the chip in a first orientation to move a gas bubble away from the detection region;
capturing of the gas bubble in the predetermined gas containing region;
detecting a property of the liquid sample present in the detection region; and
moving the gas bubble into the detection region by changing the orientation of the chip to a second, different orientation.

48. A method as in claim 47, further comprising changing the orientation of the chip from the first orientation to a substantially horizontal orientation before detecting the property of the liquid.

49. A method as in claim 47, wherein the chip comprises an impediment positioned in the container, the impediment being constructed and arranged to contain a gas within the predetermined gas containing region.

50. A method as in claim 49, wherein an outlet is in fluid communication with the reaction site container, further comprising adding a second liquid and containing the gas within the predetermined gas containing region and in fluid communication with the outlet such that adding the second liquid forces a portion of the gas out of the reaction site container through the outlet.

51. A method as in claim 50, wherein the second liquid is different from the liquid sample.

52. A method as in claim 49, wherein capturing the gas bubble comprises moving the gas bubble past the impediment.

53. A method as in claim 52, wherein moving the gas bubble past the impediment comprises moving the gas bubble under the impediment.

54. A method as in claim 52, wherein moving the gas bubble past the impediment comprises moving the gas bubble around the impediment.

55. A method as in claim 52, wherein capturing the gas bubble comprises having a lower energy interaction between the surface energy of the gas bubble and the surface energy of the gas-containing region than between the surface energy of the gas bubble and the surface energy of the detection region.

56. A method as in claim 47, wherein the detection region and the predetermined gas containing region are within the reaction site container.

57. A method as in claim 47, wherein the reactor chip is capable of maintaining at least one living cell.

58. A method as in claim 57, wherein the at least one living cell is mammalian.

59. A method as in claim 47, wherein a first wall of the predetermined reaction site is defined by a first gas permeable, liquid vapor impermeable membrane.

60. An apparatus, comprising:
a chemical, biological, or biochemical reactor chip comprising a fluid channel in fluid communication with an elongate container having a volume of less than about 2 mL; wherein
the container has an interior perimeter surface, a first end, a length, and a maximum width; and
the interior perimeter surface has a radius of curvature greater than or equal to 93 percent of the maximum container width along the portions of the interior perimeter surface that are: (a) spaced longitudinally from the first container end at a distance of at least 5% of the container length; and (b) spaced longitudinally no further from the first container end than the nearest maximum container width is spaced longitudinally from the first container end.

61. An apparatus as in claim 60, wherein the container width is less than or equal to 11 millimeters.

62. An apparatus as in claim 61, wherein the container length is less than or equal to 38 millimeters.

63. An apparatus, comprising:
a chemical, biological, or biochemical reactor chip comprising a fluid channel in fluid communication with a predetermined reaction site having a volume of less than about 2 milliliters; wherein
the predetermined reaction site has an interior perimeter surface that has at least one concave portion and at least one convex portion.
